(19) United States
(12) Patent Application Publication
(10) Pub. No.: US 2003/0041170 A1
(43) Pub. Date: Feb. 27, 2003

(54) System providing a virtual private network service

(76) Inventor: Hiroyuki Suzuki, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/998,550

(22) Filed: Nov. 29, 2001

(30) Foreign Application Priority Data
Aug. 23, 2001 (JP) 2001-253308

(51) Int. Cl. G06F 15/173

(52) U.S. Cl. 709/238

(57) ABSTRACT

A router comprises a plurality of VR ports for each user of a virtual private network service. Each VR port comprises a routing table for a corresponding virtual private network. A control channel terminating unit and a VPN configuration module set up an L2TP tunnel between VR ports belonging to the same virtual private network. A gateway protocol daemon exchanges routing information via the established L2TP tunnel, and generates/updates a routing table. An input packet is routed according to the routing table.

### Background of the Invention

1. Field of the Invention

The present invention relates to a virtual private network configured by using an IP network, and a router used for the virtual private network.

2. Description of the Related Art

Conventionally, a lot of users configure a private network (or a self-administered network). The private network is a network allowing a data transfer only between terminals within a certain group, and was conventionally configured by using a dedicated line. In recent years, however, there have been moves afoot to configure a virtual private network by using an IP network such as the Internet, etc. open to an indefinitely large number of people due to the demand for reducing communications cost, or the like. The Internet is an IP network widely open to worldwide users, and configured by many routers.

On the Internet, data is fundamentally transferred by being stored in an IP packet. Here, each IP packet is assigned a destination address. Upon receipt of an IP packet, each router determines the path of the IP packet according to an assigned destination address. In this case, a routing table is referenced when the path is determined.

The routing table includes information for determining the transfer path of an IP packet, and is set and managed with a routing algorithm. For example, information representing the correspondence between a destination network and a next hop is registered to the routing table. In this case, a router determines a next hop by searching the routing table by using the destination address of a received IP packet as a search key, and transmits the IP packet to the next hop. Each router on the path performs the above describe process, so that the IP packet is transferred to the destination address.

A virtual private network on the Internet is normally implemented by IP Tunneling. As a representative of the IP tunneling, for example, PPTP (Point-to-Point Tunneling Protocol) of Microsoft Corporation, L2F (Layer 2 Forwarding) of Cisco Systems Inc., etc. are known. Currently, L2TP (Layer2 Tunneling Protocol) into which these two protocols are merged is becoming popular. Here, L2TP is a protocol encrypting a data packet in a data link layer while tunneling PPP (Point-to-Point Protocol) data. L2TP was standardized by the IETF (Internet Engineering Task Force), and laid down as RFC2661.

As described above, a method configuring a virtual private network by using the Internet is under study by the IETF, etc. However, all of specifications have not been discussed. For instance, it cannot be said that sufficient discussion has been made for a method ensuring security.

For example, each router performs a routing process by using one routing table in the present situation. The routing table stores routing information for a general user, and routing information for a virtual private network service user. Namely, the routing table is shared for an indefinitely large number of users.

Accordingly, the routing information stored in the routing table can possibly be stolen or rewritten due to an illegal access. Namely, if routing information is stolen and analyzed, the network configuration of a virtual private network service user is learned. Additionally, information transmitted within the virtual private network can possibly be wiretapped by rewriting routing information.

As one method of implementing a virtual private network, MPLS-VPN (Multi-Protocol Label Switching-Virtual Private Network) is known. With this method, however, if attempts are made to interconnect networks respectively arranged at a plurality of sites, they result in mutually independent ASs (Autonomous Systems). Namely, one autonomous system cannot be configured as a whole. Accordingly, it is difficult to shift a virtual private network to which a plurality of networks are connected with dedicated lines to a virtual private network using the Internet.

### SUMMARY OF THE INVENTION

An object of the present invention is to improve the security of a virtual private network using an IP network.

A system providing a virtual private network service according to the present invention is a system that uses an IP network including a plurality of routers. A router, which accommodates a user of the virtual private network service, comprises a virtual router unit corresponding to each user of the virtual private network service. The virtual router unit comprises a routing table storing routing information for transferring a packet of a corresponding user, and a routing unit controlling the transfer of the packet of the corresponding user by referencing the routing table.

In the above described system, a routing table is separated for each virtual private network, and a virtual private network service is provided by using the routing table. Accordingly, the security of each virtual private network is high.

The above described system may further comprise a setting unit setting up a control channel for transferring the routing information in between virtual router units belonging to the same virtual private network. With this configuration, information for generating a routing table is independently transmitted/received for each virtual private network, so that the security can be further improved.

### BRIEF DESCRIPTION OF THE DRAWINGS

FIG. 1 shows the configuration of a system relating to a virtual private network, according to an embodiment;

FIG. 2 explains the concept of a method configuring the virtual private network according to the embodiment;

FIG. 3 exemplifies an update of a routing table;

FIG. 4 schematically shows the structure of a routing area providing a virtual private network;

FIG. 5 shows the configuration of a router in the embodiment;

FIG. 6A exemplifies a routing table;

FIG. 6B exemplifies a VPN configuration map;

FIG. 7 explains a sequence when a VR port is added;

FIG. 8 is a flowchart showing the process for generating a routing table in a newly added VR port;

FIG. 9 is a flowchart explaining the operations of an existing VR port, which are performed when a new VR port is added;

FIG. 10 is a flowchart showing the process of a VR port remaining when a VR port is deleted;

FIG. 11 and FIG. 12 exemplify the configuration of a virtual private network; and

FIG. 13 exemplifies the procedure for setting up a label path between VR ports.

### DESCRIPTION OF THE PREFERRED EMBODIMENTS

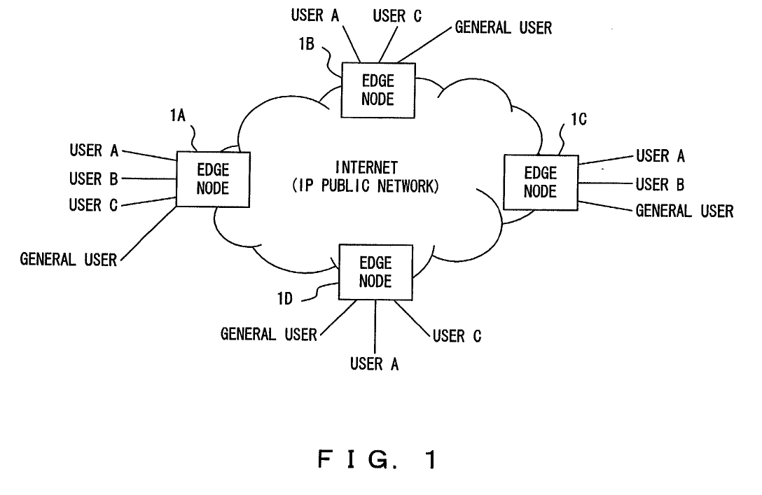

FIG. 1 shows the configuration of a system relating to a virtual private network (VPN), according to an embodiment. Here, assume that a virtual private network service is provided to users A, B, and C, respectively.

The virtual private network according to this embodiment is configured by using the Internet, which is an IP public network. Here, a large number of communication nodes are connected to the IP public network, and users are respectively accommodated by corresponding edge nodes 1A through 1D. Additionally, communication nodes (including the edge nodes 1A through 1D) are, for example, communication devices such as a router, etc. A virtual private network configured by using the IP public network is frequently called “IP-VPN”.

Each of the users (A through C) has terminals at a plurality of sites. For example, the user A has the terminals at the sites respectively managed by the edge nodes 1A through 1D. Note that only one terminal, or a LAN (Local Area Network) to which a plurality of terminals are connected may be arranged at each of the sites.

A virtual private network is a virtually closed network. Accordingly, an IP packet transmitted/received within each virtual private network is never transmitted to a terminal belonging to a different virtual private network, or a terminal of a general user. Additionally, within the virtual private network, an IP packet may be transferred by using an IP tunnel such as L2TP, etc, or by using a label path of MPLS (Multi-Protocol Label Switching).

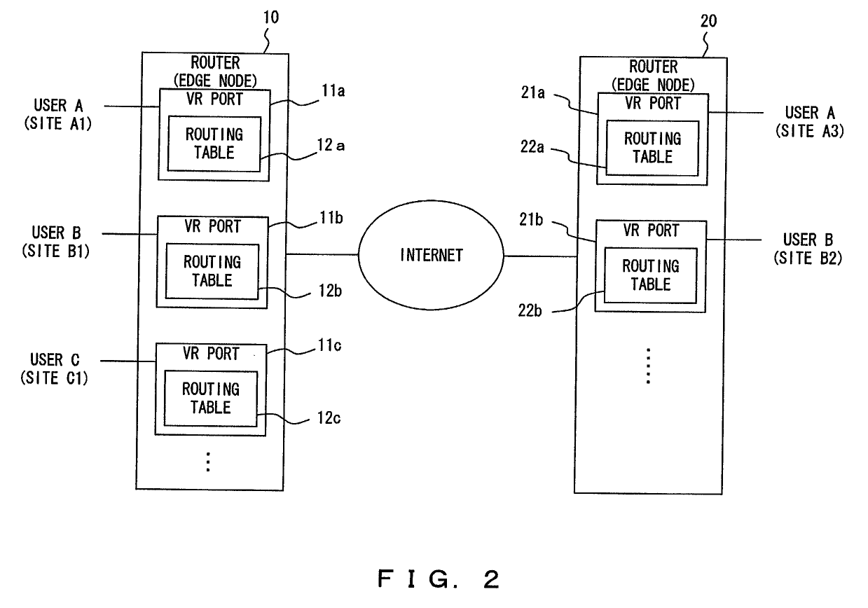

FIG. 2 explains the concept of a method configuring the virtual private network, according to the embodiment. This figure shows only two edge nodes. Here, assume that the edge nodes are routers.

The routers 10 and 20 can respectively accommodate a plurality of users. Here, the router 10 accommodates users A, B, and C, whereas the router 20 accommodates the users A and B. The routers 10 and 20 respectively comprise VR (Virtual Router) ports which respectively correspond to the users. In this embodiment, the router 10 comprises a VR port 11a corresponding to the user A, a VR port 11b corresponding to the user B, and a VR port 11c corresponding to the user C. Similarly, the router 20 comprises a VR port 21a corresponding to the user A, and a VR port 21b corresponding to the user B. Each of the users and a corresponding VR port are fundamentally connected in a one-to-one correspondence.

Each of the VR ports comprises a routing table. Here, the routing table is generated for each virtual private network. Namely, routing tables 12a and 22a, which are respectively comprised by the VR ports 11a and 21a, store only the routing information for the virtual private network of the user A. Likewise, routing tables 12b and 22b store only the routing information for the virtual private network of the user B, and a routing table 12c stores only the routing information for the virtual private network of the user C.

Furthermore, each of the VR ports exchanges control information such as routing information, etc. only with a VR port belonging to the same virtual private network. At this time, these items of control information are transmitted/received via an IP tunnel formed with L2TP, etc. For example, the VR port 11a can establish an L2TP tunnel only to the VR port 21a, but cannot establish it to other VR ports. Accordingly, the routing information stored in the routing table 12a of the VR port 11a is transmitted only to the VR port 21a via the L2TP tunnel in this case. Additionally, at this time, the VR port 11a can receive the routing information stored in the routing table 22a of the VR port 21a via the L2TP tunnel. In this way, each of the VR ports generates/updates routing information based on the exchanged routing information.

As a method transmitting/receiving routing information between edge nodes, a known technique is available. The method maybe implemented, for example, with OSPF (Open Shortest Path First). With the OSPF, when one edge node transmits information to the other, a routing table of a router arranged on the path is updated. In this embodiment, each of the VR ports operates as an edge node. Namely, routing information is exchanged between VR ports, and routing tables respectively arranged for the VR ports, and a routing table arranged for each router on a path are generated/updated.

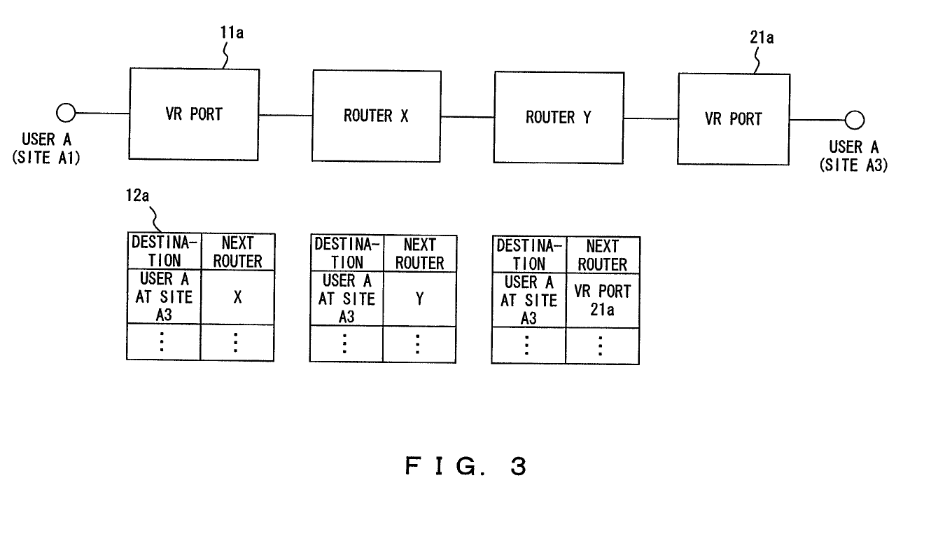

One example is given below. Here, assume the case where routing information is exchanged between the VR ports 11a and 21a. For instance, routing information transferred from the VR port 21a to the VR port 11a includes information such that “a packet addressed to the terminal of the user A, which is arranged at a site A3, is transferred to the VR port 21a of the router 20”. In this case, as shown in FIG. 3, the routing table of the VR port 11a, and routing tables of routers arranged on the path between the VR ports 21a and 11a are updated. To be more specific, information for transferring a packet addressed to the user A at the site A3 to the VR port 21a is registered to the routing table of the router Y. Additionally, information for transferring the packet addressed to the user A at the site A3 to the router Y is registered to the routing table of the routerX. Furthermore, information for transferring the packet addressed to the user A at the site A3 to the router X is registered to the routing table 12a of the VR port 11a. Similarly, routing information transferred from the VR port 11a to the VR port 21a includes information such that “a packet addressed to the terminal of the user A, which is arranged at the site A1, is transferred to the VR port 11a of the router 10”.

As described above, the router in this embodiment comprises a VR port for each virtual private network. Each VR port manages routing information for a corresponding virtual private network, and the routing information is exchanged only between VR ports belonging to the same virtual private network. As a result, routing information is separated for each virtual private network, whereby security of each virtual private network is improved.

The routing process of a packet transmitted within a virtual private network is performed by a corresponding VR port. For instance, when a packet addressed to the terminal of the user A, which is arranged at the site A3, is transmitted from the terminal of the user A, which is arranged at the site A1, this packet is first received by the VR port 11a of the router 10. The VR port 11a extracts routing information from the routing table 12a by using the destination address of the received packet as a search key, and transmits the packet according to the routing information. In this case, the packet is transferred to the VR port 21 via the routers X and Y according to the routing information shown in FIG. 3. Then, the VR port 21a transfers the packet to the user A at the site A3. In this way, a packet transmitted/received between terminals is transferred within a virtual private network established by VR ports.

FIG. 3 shows the general routing tables. Also for a routing table using a label, its generation/updating procedure is fundamentally the same.

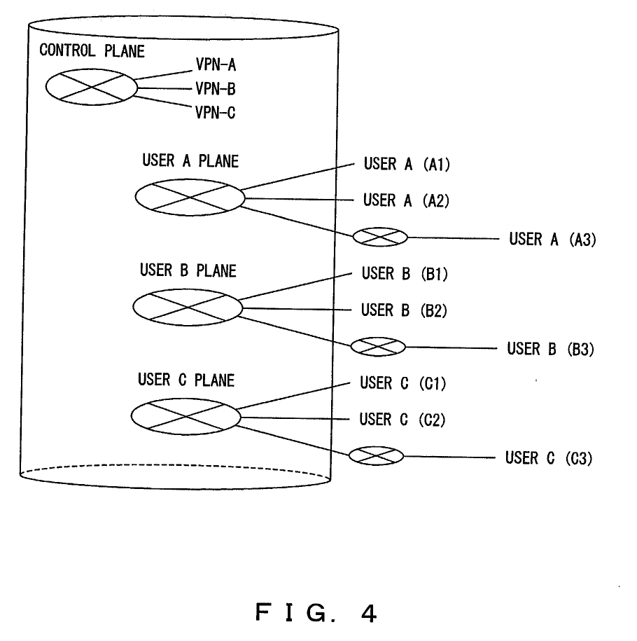

FIG. 4 schematically shows the structure of a routing area providing a virtual private network. The routing area has a hierarchical structure, and is configured by a control plane and a user plane. The control plane is an area for transmitting/receiving control information between VR ports. Since the control information is transmitted/received via a tunnel established for each virtual private network as described above, it is separated one another for each virtual private network. In the meantime, the user plane is an area for transmitting main signals (data transmitted between terminals). Here, a router comprises a VR port arranged for each virtual private network as described above. Additionally, the main signals within each virtual private network are routed by a corresponding VR port. Accordingly, the user plane is separated into planes for respective virtual private networks.

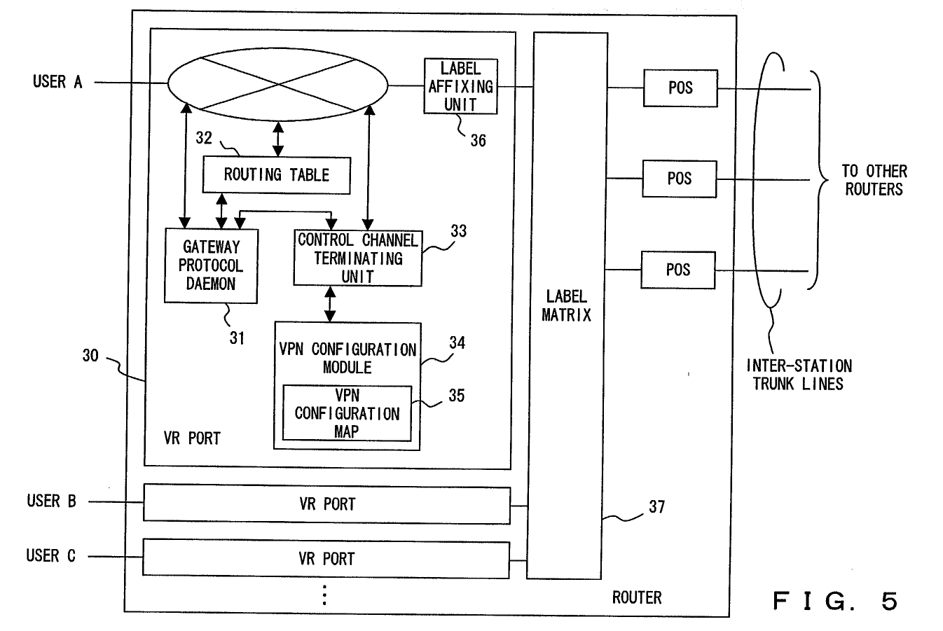

FIG. 5 shows the configuration of the router in the embodiment. Here, the router accommodates pluralities of user lines and inter-station trunk lines connected to another router. Each of the user lines is connected to its corresponding VR port.

The router comprises one or a plurality of VR ports 30 as described above. Each of the VR ports 30 comprises a gateway protocol daemon 31, a routing table 32, a control channel terminating unit 33, a VPN configuration module 34, a label affixing unit 36, etc.

The gateway protocol daemon 31 provides the fundamental operations of the router. Specifically, the gateway protocol daemon 31 performs processes such as a process for generating/updating a routing table, a process for determining the route of a packet, and the like. The gateway protocol daemon 31 comprises a capability for transferring an IP packet, for example, via an MPLS (Multi-Protocol Label Switching) network. Additionally, the gateway protocol daemon 31 may comprise a capability for performing mutual conversion between a private address and a global address.

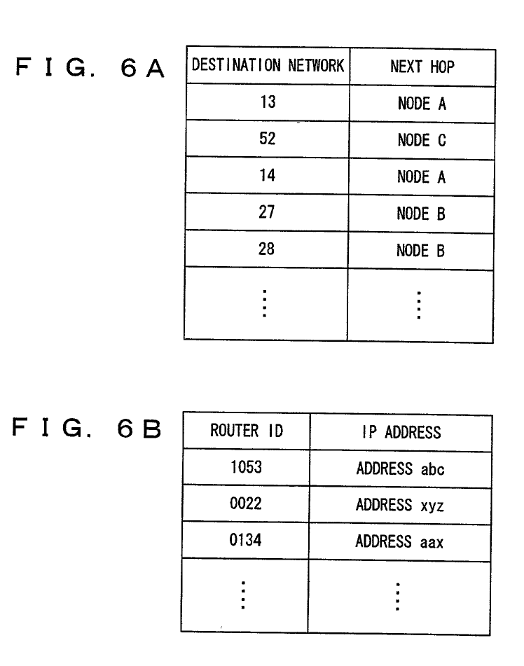

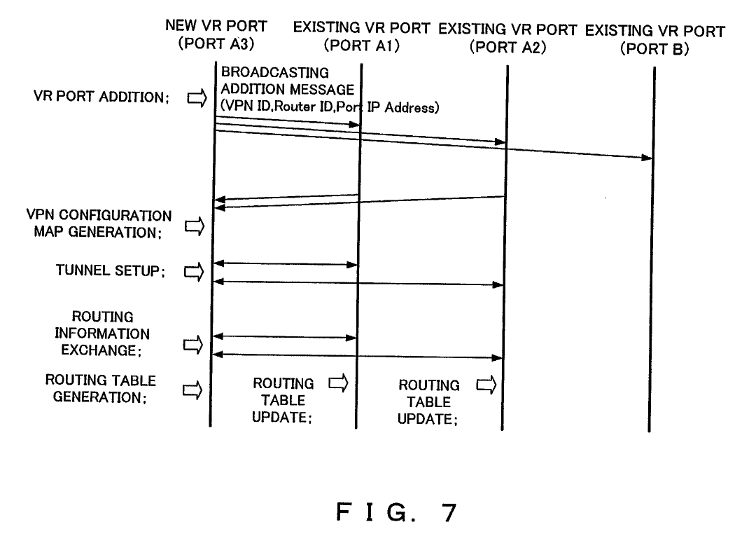

In the routing table 32, routing information for a corresponding virtual private network is stored. Here, the routing table 32 is set/managed with a predetermined routing algorithm. As an example, a combination of a destination network and a next hop is registered as shown in FIG. 6A. In this case, the router (VP port) determines the next hop by searching the routing table with the use of the destination address of a received IP packet as a search key, and transmits the IP packet to the next hop. Note that the structure of the routing table is not limited particularly.

The control channel terminating unit 33 terminates a control channel for transmitting control information (routing information, etc.) between VR ports. Here, the control channel is implemented by an L2TP tunnel. Accordingly, the control channel controlling unit 33 comprises an L2TP client and an L2TP server. The L2TP client is a program unit that makes a request to set up an L2TP tunnel. The L2TP server is a program unit that establishes an L2TP tunnel at the request of the L2TP client.

The VPN configuration module 34 authenticates a VR port connected to a control channel when the control channel is set up. For the authentication, the VPN configuration module 34 comprises a RADIUS client and a RADIUS server. The RADIUS client is a program unit that makes a request to authenticate a VR port, whereas the RADIUS server is a program unit that authenticates the VR port at the request of the RADIUS client.

Additionally, the VPN configuration module 34 comprises a capability for monitoring/controlling a control channel. Specifically, the VPN configuration module 34 periodically transmits a monitoring message via the control channel, and monitors whether or not a reply message can be received from a corresponding VR port. If the reply message cannot be received, the VPN configuration module 34 performs a process for deleting the corresponding control channel, and the like.

Furthermore, the VPN configuration module 34 generates a VPN configuration map 35 defining the configuration of a corresponding virtual private network. The VPN configuration map 35 includes at least a list of router IDs for identifying routers relating to a corresponding virtual private network. Here, “the routers relating to the virtual private network” indicate routers which accommodate terminals belonging to that virtual private network. The VPN configuration map 35 maybe a map to which IP addresses of VR ports accommodating terminals are registered as shown in FIG. 6B.

The label affixing unit 36 affixes a label for MPLS label switching to an IP packet. The label switching is a known technique. For example, a tag switch (RFC 2105), a cell switch router (RFC 2098), etc. are known.

A label matrix 37 guides an IP packet output from a VR port to a corresponding inter-station trunk line in accordance with a label. Additionally, the label matrix 37 guides an IP packet input from an inter-station trunk line to a VR port corresponding to a label.

As described above, in the system according to this embodiment, main signals (data transmitted between terminals) is transmitted via an MPLS network. Here, an MPLS label path is set by a VR port arranged for each virtual private network. Accordingly, each label path is closed within a VR port in each virtual private network. Therefore, user data in a virtual private network is never be wiretapped.

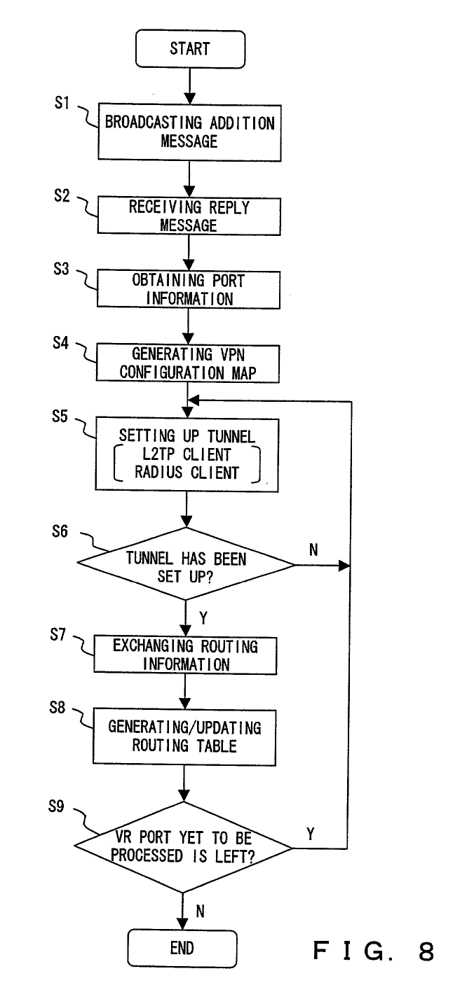

FIG. 7 explains the sequence when a VR port is added. Here, assume that VR ports (A1) and (A2) are already arranged for the virtual private network of a user A (hereinafter referred to as a virtual private network A), and a VR port (A3) is added to expand this virtual private network.

To each of the VR ports, a VPN identifier for identifying a corresponding virtual private network is assigned. For example, a VPN identifier for identifying the virtual private network A is assigned to each of the VR ports (A1) through (A3). Also an IP address is assigned to each of the VR ports.

In this case, the VR port (A3) broadcasts an addition message to all of routers. The addition message includes the VPN identifier for identifying the virtual private network A, the router identifier for identifying the router accommodating the VR port (A3), and the IP address assigned to the VR port (A3). This addition message is received by each of the VR ports of each of the routers.

Upon receipt of the addition message, the VR ports (A1) and (A2) return a reply (ACK) message to the VR port (A3). This reply message includes the VPN identifier, the router identifier, and the IP address of the corresponding VR port likewise the addition message. Note that a VR port to which the VPN identifier for identifying the virtual private network A is not assigned does not return a reply message, even if it receives the addition message. In the example shown in FIG. 7, a VR port (B) does not return a reply message.

The VR port (A3) generates a VPN configuration map which represents the configuration of the virtual private network A based on the received reply message. In this embodiment, recognition such that the VR ports (A1) and (A2) belong to the virtual private network A is made, and a VPN configuration map corresponding to this recognition result is generated.

Then, L2TP tunnels are respectively set up between the VR ports (A3) and (A1), and between the VR ports (A3) and (A2). Then, routing information are respectively exchanged via these L2TP tunnels. As a result, a routing table is generated in the VR port (A3). In the meantime, the routing tables are updated in the VR ports (A1) and (A2).

As described above, when a new VR port is added, routing information is exchanged between the new VR port and an existing VR port, and a routing table is generated/updated. Here, routing information is exchanged between VR ports belonging to the same virtual private network. Besides, the routing information is transferred via an L2TP tunnel established between the VR ports. Accordingly, the security of each virtual private network is high.

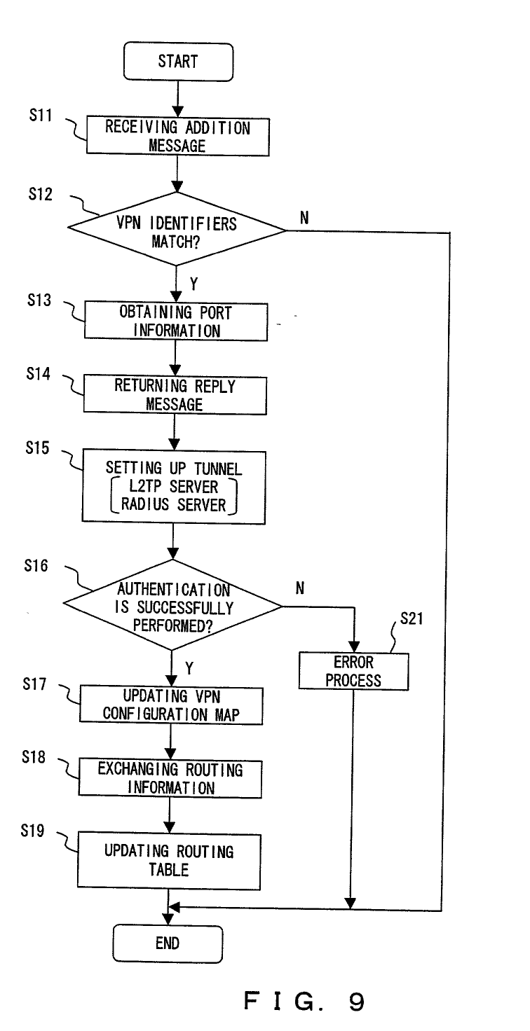

FIG. 8 is a flowchart showing the process for generating a routing table in a newly added VR port. Explanation is provided below with reference to the sequence shown in FIG. 7. Namely, the operations of the VR port (A3) in the sequence shown in FIG. 7 are described.

In step S1, an addition message is broadcast to all of the routers. As described above, this addition message includes the VPN identifier for identifying the virtual private network A, the router identifier for identifying the router accommodating the VR port (A3), and the IP address assigned to the VR port (A3).

In step S2, a message in reply to the addition message transmitted in step S1 is received. This reply message is returned only from the VR ports belonging to the virtual private network A.

In step S3, necessary information is obtained from the received reply message. To be more specific, the IP address of the VR port that has transmitted the reply message, the router identifier of the router accommodating the VR port, etc. are obtained.

In step S4, a VPN configuration map is generated based on the information obtained in step S3. This VPN configuration map represents the configuration of the virtual private network. One example of the VPN configuration map is shown in FIG. 6B.

Operations in steps S5 through S9 are performed for each VR port that has transmitted a reply message. In the example shown in FIG. 7, these operations are performed for the VR ports (A1) and (A2). The case where the operations are performed for the VR port (A1) is described below.

In step S5, the L2TP client and the RADIUS client are invoked to set up an L2TP tunnel between the VR port (A1) and the VR port (A3). At this time, information required to authenticate the VR port (A3) is transmitted to the VR port (A1). If the authentication of the VR port (A3) is successfully made in the VR port (A1), an L2TP tunnel is set up between the VR ports (A3) and (A1). In this case, the tunnel identifier for identifying this L2TP tunnel is determined, and the VR ports (A3) and (A1) respectively manage this tunnel identifier thereafter. If the authentication is unsuccessfully made, the process is terminated (step S6).

In step S7, routing information is exchanged with the VR port (A1) by using the L2TP tunnel set up in step S5. Specifically, routing information stored in the routing table of the VR port (A1) is obtained. If the VR port (A3) already comprises a routing table, the routing information stored in that table is transmitted to the VR port (A1).

In step S8, a routing table is generated, and the routing information received in step S7 is registered to the generated table. If the routing table has already been generated at this time, this table is updated according to the received routing information. Thereafter, it is checked whether or not a VR port yet to be processed is left. If a VR port yet to be processed is left, the process goes back to step S5.

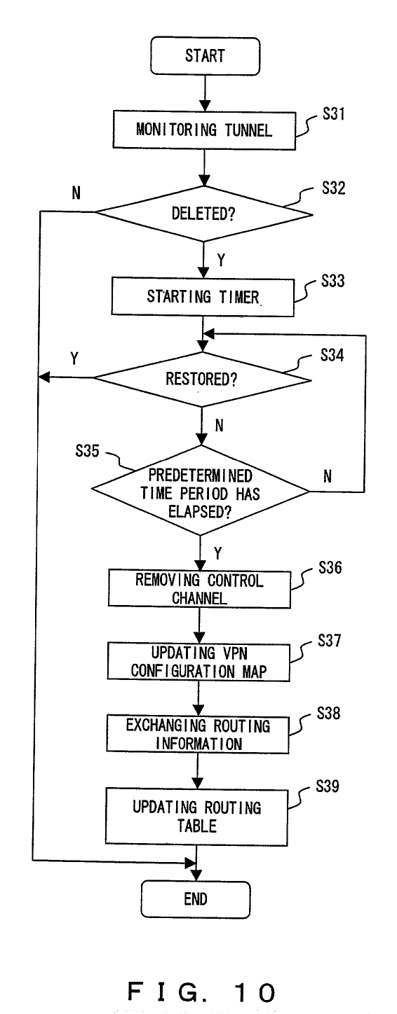

FIG. 9 is a flowchart explaining the operations of an existing VR port, which are performed when a new VR port is added. The operations of the VR port (A1), the VR port (A2), or the VR port (B), which is shown in FIG. 7, are explained below.

In step S11, an addition message is received from the VR port (A3). The addition message is similar to the above described one.

In step S12, a comparison is made between the VPN identifier for identifying the virtual private network to which the corresponding VR port belongs, and the VPN identifier set in the received addition message. If they match, recognition such that the VR port is added in the virtual private network A is made. The process then goes to step S13. If they mismatch, the process is terminated.

In step S13, necessary information is obtained form the received addition message. Specifically, the IP address of the VR port that has transmitted the addition message, the router identifier of the router accommodating that VR port, etc. are obtained. Then, in step S14, a reply message is generated and returned to the VR port (A3).

In step S15, the L2TP server and the RADIUS server are invoked to set up a requested L2TP tunnel. This operation is performed upon receipt of a setup request from the L2TP client and an authentication request from the RADIUS client. In this embodiment, the request to authenticate the VR port (A3) is received.

If the authentication of the VR port (A3) is successfully made, the operations in steps S17 through S19 are performed. If the authentication is unsuccessfully made, a corresponding error process is performed in step S21.

In step S17, a VPN configuration map is generated based on the information obtained in step S13. This VPN configuration map represents the configuration of the virtual private network A. One example of the VPN configuration map is earlier shown in FIG. 6B.

In step S18, routing information is exchanged with the VR port (A3) by using the L2TP tunnel set up in step S15. Specifically, routing information stored in the routing table of the corresponding VR port is transmitted to the VR port (A3). If the VR port (A3) already has a routing table, routing information stored in the table is received. Then, in step S19, the routing table is updated according to the routing information received in step S18.

As described above, if a VR port is added to expand a virtual private network, IP tunnels are respectively set up between the VR port and other VR ports belonging to the same virtual private network. Then, routing information is transmitted/received via the IP tunnels. Accordingly, a routing table is generated for each virtual private network in each router, whereby security of each virtual private network is improved.

In the above described embodiment, an L2TP tunnel is used as an IP tunnel for transferring routing information between VR ports. However, the present invention is not limited to this implementation. Additionally, although RADIUS is used as an authentication protocol in the above described embodiment, the present invention is not limited to this protocol. The above described embodiment is a system with which an existing VR port authenticates a newly added VR port. However, the present invention may be a system with which an existing port and a newly added VR port perform mutual authentication.

Next, the operations performed when a VR port is deleted are described. If a virtual private network is reduced, a corresponding VR port is deleted. For example, if a certain LAN is abolished or disconnected in a virtual private network to which a plurality of LANs are connected by using an IP network, the VR port corresponding to the LAN is deleted. In this case, the remaining VR ports must respectively release the L2TP tunnel connected to the deleted VR port, and update their routing tables.

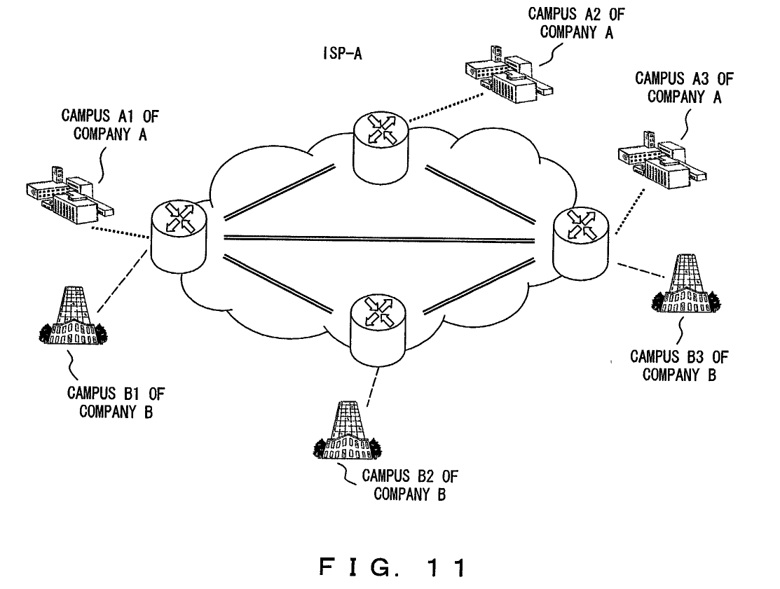

FIG. 10 is a flowchart showing the operations of a VR port remaining when a certain VR port is deleted. Here, assume that an L2TP tunnel for transferring routing information is set up between VR ports within the same virtual private network with the procedures shown in FIGS. 7 through 9. Also assume that the operations of this flowchart are periodically performed.

In step S31, the state of the L2TP tunnel is monitored. The state of the L2TP tunnel is judged, for example, in a way such that one VR port connected to the tunnel transmits a monitoring message to the other VR port, and whether or not a message in reply to the monitoring message is returned is determined. If the VR port that has transmitted the monitoring message can receive the corresponding reply message, the L2TP tunnel is determined to be normal. If a plurality of L2TP tunnels are set up, similar operations are performed for each of the tunnels.

If the L2TP tunnel is determined to be abnormal, it is determined in step S32 that a corresponding VR port may possibly be deleted. Operations in and after step S33 are then performed.

In step S33, a timer is started. In steps S34 and S35, it is examined whether or not the corresponding VR port is restored within a predetermined time period (for example, 24 hours) from the start of the timer. Whether or not the corresponding VR port is restored can be determined by using the above described monitoring message. If the corresponding VR port is restored within the predetermined time period, the timer is cleared, and the process is terminated.

If the corresponding VR port is not restored within the predetermined time period, the control channel (L2TP tunnel) set up between the above described VR port and the corresponding VR port is removed in step S36. When the control channel is removed, for example, various types of parameters stipulating the L2TP tunnel are released.

In step S37, a VPN configuration map is updated. To be more specific, information about the removed VR port is deleted from the VPN configuration map. Then, in step S38, routing information is exchanged between remaining VR ports belonging to the same virtual private network. In step S39, routing tables are updated according to the exchanged routing information.

As described above, if a VR port belonging to a virtual private network is deleted, a control channel connected to the deleted VR port is removed by the other VR ports belonging to the virtual private network. Then, the remaining VR ports update their routing tables depending on need.

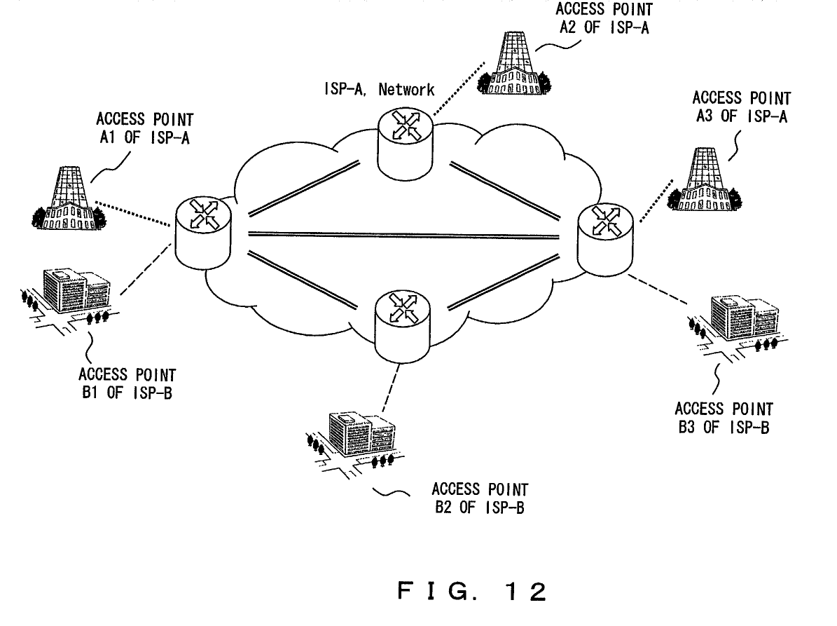

FIGS. 11 and 12 exemplify the configuration of a virtual private network. In the example shown in FIG. 11, users that receive a virtual private network service are private companies respectively having a plurality of business sites. Campus networks at the business sites are interconnected by a virtual private network for each of the users.

In the example shown in FIG. 12, users that receive a virtual private network service are ISPs (Internet Service Providers) respectively having a plurality of access points. A virtual private network is configured for each of the ISPs.

In the present invention, the routing information is not limited to information transferred with a routing protocol of an IP layer, and assumed to include all items of information for determining the route of an IP packet. For example, the routing information includes the information for setting an MPLS label path. The label path can be set, for example, with LDP (Label Distribution Protocol).

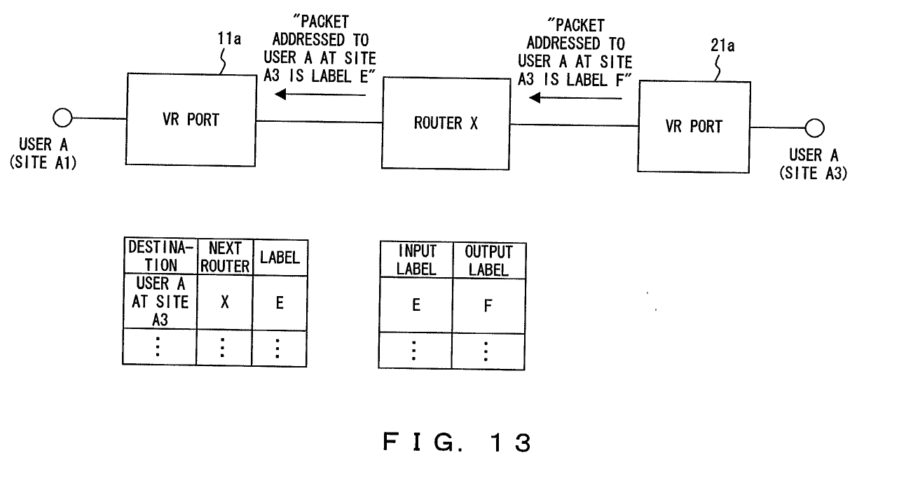

FIG. 13 exemplifies the procedure for setting up a label path between VR ports. Here, assume the case where routing information for a label path is exchanged between the VR ports 11a and 21a in a similar manner as in the case shown in FIG. 3. For instance, routing information transferred from the VR port 21a to the VR port 11a includes information that “a packet addressed to the terminal of the user A, which is arranged at the site A3, is a label F”. In this case, the router X that receives this information transmits to the VR port 11a the routing information including the information “a packet addressed to the terminal of the user A, which is arranged at the site A3, is a label E”. As a result, the VR port 11a and the router X respectively generate tables shown in FIG. 13.

These routing information are transferred via the IP tunnel set up between the VR ports 11a and 21a in a similar manner as in the above described embodiment.

When a packet addressed to the terminal of the user A, which is arranged at the site A3, is transmitted from the terminal of the user A, which is arranged at the site A1, after the tables are generated, the packet is first received by the VR port 11a of the router. The VR port 11a affixes a label E to the packet, and transmits the packet to the router X. Upon receipt of the packet, the router X transmits the packet to the VR port 21a after rewriting the label from E to F. The VR port 21a then transfers the packet to the user A at the site A3.

According to the present invention, a routing table is generated for each virtual private network, whereby security of each virtual private network is improved.

What is claimed is:

1. A system providing a virtual private network service by using an IP network including a plurality of routers, wherein
a router, which accommodates a user of the virtual private network service, comprises a virtual router unit corresponding to each user of the virtual private network service, and
the virtual router unit comprising
a routing table storing routing information for transferring a packet of a corresponding user, and
a routing unit controlling a transfer of a packet of a corresponding user by referencing said routing table.

2. The system according to claim 1, further comprising
a setting unit setting up a control channel for transferring the routing information between virtual router units belonging to the same virtual private network.

3. The system according to claim 2, wherein
the control channel is an IP tunnel.

4. The system according to claim 1, wherein:
identification information for identifying a virtual private network corresponding to a first virtual router unit arranged within a first router is broadcast from the first virtual router unit to other routers;
reply information is returned from a virtual router unit, which belongs to a same virtual private network as a virtual private network identified according to the identification information, to the first virtual router unit; and
the first virtual router unit detects a configuration of a corresponding virtual private network based on the reply information.

5. The system according to claim 1, wherein:
identification information for identifying a virtual private network corresponding to a first virtual router unit arranged within a first router is broadcast from the first virtual router unit to other routers;
reply information is returned from a second virtual router unit, which belongs to a same virtual private network as a virtual private network identified according to the identification information, to the first virtual router unit; and
a control channel for transferring the routing information is set up between the first virtual router unit and the second virtual router unit.

6. The system according to claim 5, wherein:
the first virtual router unit has an authentication client unit making a request to authenticate the first virtual router unit; and
the second virtual router unit has an authentication server unit performing authentication of the first virtual router unit at the request of the authentication client.

7. The system according to claim 2, wherein
if one of a plurality of virtual router units belonging to a certain virtual private network is deleted, a control channel connected to the deleted virtual router unit is removed, and a configuration map representing a configuration of the virtual private network is updated in remaining virtual router units.

8. The system according to claim 7, wherein
the configuration map is updated after a predetermined time period elapses from when the control channel is removed.

9. A router apparatus used in a system providing a virtual private network service by using an IP network, comprising
a virtual router unit corresponding to each user of the virtual private network service, wherein
said virtual router unit comprises
a routing table storing routing information for transferring a packet of a corresponding user, and
a routing unit controlling a transfer of a packet of a corresponding user by referencing said routing table.
